(19) United States
(12) Patent Application Publication
(10) Pub. No.: US 2012/0045065 A1
(43) Pub. Date: Feb. 23, 2012

(54) SURROUND SIGNAL GENERATING DEVICE, SURROUND SIGNAL GENERATING METHOD AND SURROUND SIGNAL GENERATING PROGRAM

(75) Inventor: Hiroyuki Ishihara, Kawasaki (JP)

(73) Assignee: PIONEER CORPORATION, Kanagawa (JP)

(21) Appl. No.: 13/264,918

(22) PCT Filed: Mar. 17, 2009
(86) PCT No.: PCT/JP2009/057772

§ 371 Date: Oct. 17, 2011

(51) Int. Cl. H04S 5/02

(52) U.S. Cl. 381/17

(57) ABSTRACT

A surround signal generating device generates surround signals of plural channels from input sound signals of two channels, and is preferably applied to an audio device, for example. A setting unit sets a correlation value between channels in the plural channels and/or a level difference of the plural channels, in accordance with a genre of a content. A surround signal generating unit generates the surround signals of the plural channels based on the correlation value and/or the level difference which are set by the setting unit. Therefore, it becomes possible to appropriately generate the surround signals having the correlation value and/or the level difference between the channels which are appropriate for the genre of the content, from a stereo sound source.

### TECHNICAL FIELD

The present invention relates to a technical field for generating surround signals of plural channels from sound signals of two channels.

### BACKGROUND TECHNIQUE

This kind of technique is proposed in Patent Reference 1, for example. In Patent Reference-1, there is proposed a technique (Adaptive Surround Technology) for extracting a correlated component and an uncorrelated component from a momentarily varying stereo input signal by using ADF (Adaptive Digital Filter) in order to generate surround signals. Concretely, there is proposed the technique for generating the surround signals of 5.1 channels from the stereo input signal. In details, the technique assigns a component having a high correlation with a left channel and a right channel to a front-center channel, and assigns a component having a low correlation with the left channel and the right channel to a rear-left channel and a rear-right channel, in order to generate the surround signals for 5 channels.

### PRIOR ART REFERENCE

### Patent Reference

Patent Reference-1: Japanese Patent No. 3682032

### DISCLOSURE OF INVENTION

### Problem to Be Solved by The Invention

By the way, as for a real surround sound source such as a DVD, there is a tendency that a relationship of a correlation value between channels differs according to a genre of music, for example. Additionally, there is a tendency that a level on a rear side channel is smaller than a level on a front side channel . However, the technique disclosed in above Patent Reference-1 does not consider the tendencies of the real surround sound source when the surround signals are generated. Therefore, it is not possible to appropriately control a correlation value between a front channel and a rear channel.

The present invention has been achieved in order to solve the above problem. It is an object of the present invention to provide a surround signal generating device, a surround signal generating method and a surround signal generating program which can appropriately generate surround signals of plural channels in accordance with a genre of a content.

### MEANS FOR SOLVING THE PROBLEM

In the invention according to claim 1, a surround signal generating device which generates surround signals of plural channels from input sound signals of two channels, includes: a setting unit which sets a correlation value between channels in the plural channels and/or a level difference of the plural channels, in accordance with a genre of a content corresponding to the sound signals; and a surround signal generating unit which generates the surround signals of the plural channels based on the correlation value and/or the level difference which are set by the setting unit.

In the invention according to claim 13, a surround signal generating method which generates surround signals of plural channels from input sound signals of two channels, includes: a setting process which sets a correlation value between channels in the plural channels and/or a level difference of the plural channels, in accordance with a genre of a content corresponding to the sound signals; and a surround signal generating process which generates the surround signals of the plural channels based on the correlation value and/or the level difference which are set by the setting process.

In the invention according to claim 14, a surround signal generating program executed by a computer, which generates surround signals of plural channels from input sound signals of two channels, makes the computer function as: a setting unit which sets a correlation value between channels in the plural channels and/or a level difference of the plural channels, in accordance with a genre of a content corresponding to the sound signals; and a surround signal generating unit which generates the surround signals of the plural channels based on the correlation value and/or the level difference which are set by the setting unit.

### BRIEF DESCRIPTION OF THE DRAWINGS

FIG. 1 is a diagram showing an example of a 5.1-channel system.

FIG. 2 is a diagram for explaining a method for calculating a correlation value and a level difference between channels related to a surround sound source of 5.1 channels.

FIGS. 3A and 3B show examples of an analysis result of a real surround sound source.

FIGS. 4A and 4B are diagrams for explaining a basic concept of a method for generating surround signals.

FIG. 5 is a block diagram showing a surround signal generating device in a first embodiment.

FIGS. 6A to 6C are diagrams for explaining an effect of a surround signal generating method in a first embodiment.

FIG. 7 is a flow chart showing a process performed by a control unit in a surround signal generating device according to a first embodiment.

FIG. 8 is a block diagram showing a surround signal generating device in a second embodiment.

FIG. 9 is a schematic diagram showing process blocks of an uncorrelated signal generating unit.

FIGS. 10A to 10C are diagrams for explaining an effect of a surround signal generating method in a second embodiment.

### DETAILED DESCRIPTION OF THE PREFERRED EMBODIMENTS

According to one aspect of the present invention, there is provided a surround signal generating device which generates surround signals of plural channels from input sound signals of two channels, including: a setting unit which sets a correlation value between channels in the plural channels and/or a level difference of the plural channels, in accordance with a genre of a content corresponding to the sound signals; and a surround signal generating unit which generates the surround signals of the plural channels based on the correlation value and/or the level difference which are set by the setting unit.

The above surround signal generating device generates the surround signals of the plural channels from the input sound signals of the two channels, and is preferably applied to an audio device, for example. The surround signals correspond to sound signals used for more than 2 channels. Concretely, the setting unit sets the correlation value between channels in the plural channels and/or the level difference of the plural channels, in accordance with the genre of the content. The surround signal generating unit generates the surround signals of the plural channels based on the correlation value and/or the level difference which are set by the setting unit. Therefore, it becomes possible to appropriately generate the surround signals having the correlation value and/or the level difference between the channels which are appropriate for the genre of the content, from a stereo sound source.

In a manner of the above surround signal generating device, based on the correlation value between the channels in the plural channels and/or the level difference of the plural channels which are obtained from a real surround sound source for each genre, the setting unit sets the correlation value and/or the level difference. Therefore, it becomes possible to appropriately reflect a tendency of the correlation value and the level difference of the real surround sound source for each genre.

In another manner of the above surround signal generating device, the surround signal generating unit includes a mixing processing unit which determines an amount for mixing two signals between two channels in the plural channels based on the correlation value between the two channels which is set by the setting unit, and performs a process of mixing the two signals based on the amount. Therefore, it becomes possible to appropriately generate the surround signals in accordance with the correlation value between the two channels in the plural channels.

In a preferred example of the above surround signal generating device, the mixing processing unit uses, as the two signals, a sound signal obtained by performing an addition of the input sound signals of the two channels and a sound signal obtained by performing a subtraction of the input sound signals of the two channels, and performs the process of mixing the two signals. Namely, the mixing process can be performed by using the sound signals having a low correlation with each other.

As a preferred example, the two channels comprise a left channel and a right channel, and the plural channels are 5 channels comprising a front-left channel, a front-center channel, a front-right channel, a rear-left channel and a rear-right channel, and the mixing processing unit performs the process based on the correlation value of the front-center channel with respect to the front-left channel and the front-right channel, so as to generate a sound signal used for the front-center channel, and the mixing processing unit performs the process based on the correlation value of a rear channel comprising the rear-left channel and the rear-right channel with respect to the front-left channel and the front-right channel included in a front channel comprising the front-left channel, the front-center channel and the front-right channel, so as to generate sound signals used for the rear-left channel and the rear-right channel.

In another manner of the above surround signal generating device, the surround signal generating unit further includes an uncorrelated signal generating unit which generates an uncorrelated signal which is uncorrelated with each channel in the plural channels, based on the input sound signals of the two channels, and the mixing processing unit performs the process by using the uncorrelated signal. Therefore, it becomes possible to arbitrarily control the correlation value between the channels so as to generate the surround signals.

In a preferred example of the above surround signal generating device, the uncorrelated signal generating unit can generate the uncorrelated signal based on a linear prediction residual.

As a preferred example, the two channels comprise a left channel and a right channel, and the plural channels are 5 channels comprising a front-left channel, a front-center channel, a front-right channel, a rear-left channel and a rear-right channel, and the mixing processing unit performs the process by using the uncorrelated signal so as to generate sound signals used for the rear-left channel and the rear-right channel. Therefore, it becomes possible to generate the surround signals for which the correlation value between the rear-left channel and the rear-right channel is appropriately controlled.

In another manner of the above surround signal generating device, the surround signal generating unit controls the sound signals after the process by the mixing processing unit, based on the level difference of the plural channels which is set by the setting unit, so as to generate the surround signals of the plural channels. Therefore, it becomes possible to appropriately generate the surround signals having the correlation value and the level difference between the channels which are appropriate for the genre of the content.

Preferably, the setting unit can obtain the genre from an external input.

Preferably, the setting unit can obtain the genre from tag information attached to the input sound signals of the two channels.

Preferably, the above surround signal generating device further includes a unit which identifies the genre by analyzing the input sound signals of the two channels, and the setting unit can use the identified genre.

According to another aspect of the present invention, there is provided a surround signal generating method which generates surround signals of plural channels from input sound signals of two channels, including: a setting process which sets a correlation value between channels in the plural channels and/or a level difference of the plural channels, in accordance with a genre of a content corresponding to the sound signals; and a surround signal generating process which generates the surround signals of the plural channels based on the correlation value and/or the level difference which are set by the setting process.

According to still another aspect of the present invention, there is provided a surround signal generating program executed by a computer, which generates surround signals of plural channels from input sound signals of two channels, making the computer function as: a setting unit which sets a correlation value between channels in the plural channels and/or a level difference of the plural channels, in accordance with a genre of a content corresponding to the sound signals; and a surround signal generating unit which generates the surround signals of the plural channels based on the correlation value and/or the level difference which are set by the setting unit.

By the surround signal generating method and the surround signal generating program, it becomes possible to appropriately generate the surround signals having the correlation value and/or the level difference between the channels which are appropriate for the genre of the content, from a stereo sound source.

### EMBODIMENT

Preferred embodiments of the present invention will be explained hereinafter with reference to the drawings.

[Surround Signal Generating Method]

First, a description will be given of a basic concept of a surround signal generating method in the embodiment. Hereinafter, a description will be given of an example in such a case that surround signals for a 5.1-channel system are generated from input sound signals of two channels (namely, the surround signals for 5 channels are generated).

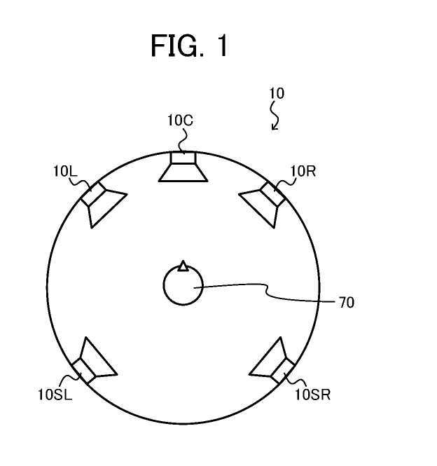

FIG. 1 is a diagram showing an example of the 5.1-channel system. FIG. 1 shows the diagram when five speakers are arranged concentrically. As shown in FIG. 1, speakers 10 include a front-left speaker 10L, a front-center speaker 10C, a front-right speaker 10R, a rear-left speaker 10SL and a rear-right speaker 10SR. In this case, a listening point is located at a position shown by a reference numeral 70, for example. Though the 5.1-channel system actually includes a subwoofer speaker, the speaker is not shown in FIG. 1.

In the specification, a channel of the front-left speaker 10L is referred to as “front-left channel”, and a channel of the front-center speaker 10C is referred to as “front-center channel”, and a channel of the front-right speaker 10R is referred to as “front-right channel”, and a channel of the rear-left speaker 10SL is referred to as “rear-left channel”, and a channel of the rear-right speaker 10SR is referred to as “rear-right channel”. Additionally, a combination of the front-left channel, the front-center channel and the front-right channel is referred to as “front channel”, and a combination of the front-left channel and the front-right channel in the front channel is referred to as “front-left-right channel”, and a combination of the rear-left channel and the rear-right channel is referred to as “rear channel”. Additionally, the front-left channel is suitably represented by “Lch”, and the front-center channel is suitably represented by “Cch”, and the front-right channel is suitably represented by “Rch”, and the rear-left channel is suitably represented by “SLch”, and the rear-right channel is suitably represented by “SRch”.

In the embodiment, a correlation value between channels in the plural channels and a level difference of the plural channels are set in accordance with a genre of an input content, and the surround signals of the plural channels are generated from the sound signals of the two channels based on the correlation value and the level difference. Namely, in the embodiment, the surround signals having the correlation value and the level difference between the channels which are appropriate for the genre of the content are generated from a stereo sound source. In this case, the correlation value and the level difference between the channels which are obtained from a real surround sound source for each genre are used. This is because, as for the real surround sound source such as a DVD, there is a tendency that a relationship of the correlation value between the channels differs according to the genre of music, for example, and there is a tendency that a level of the rear channel is smaller than that of the front channel.

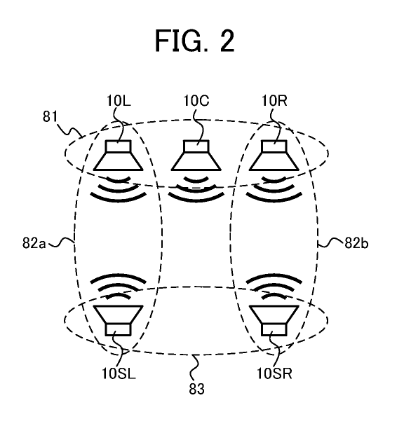

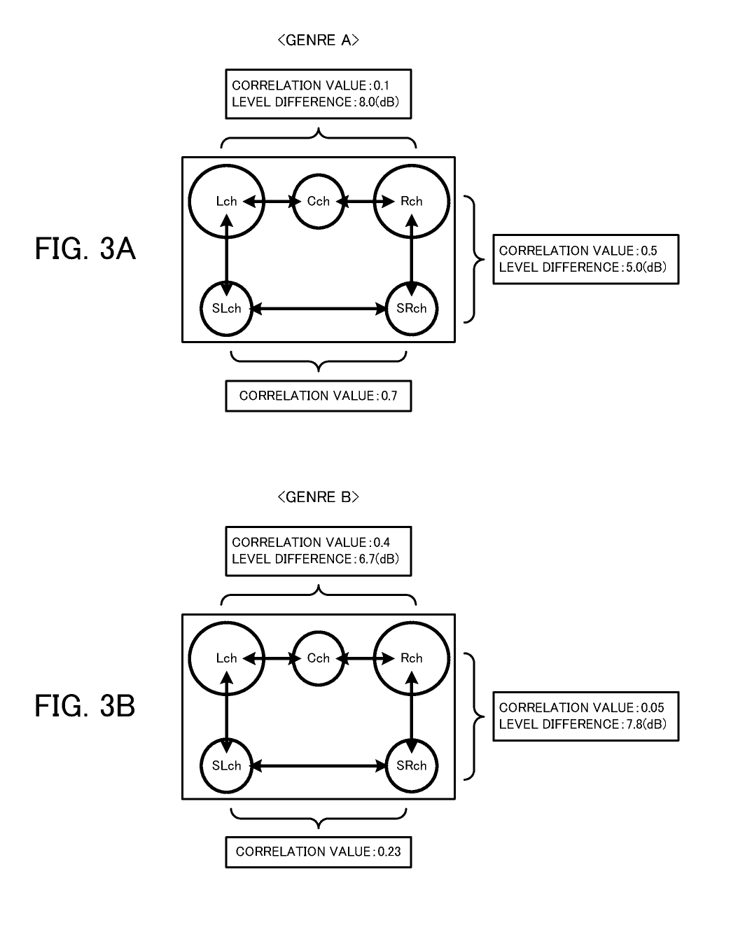

Here, a description will be given of a method for calculating the correlation value and the level difference between the channels from the real surround sound source, with reference to FIG. 2, FIGS. 3A and 3B.

FIG. 2 is a diagram for explaining the method for calculating the correlation value and the level difference between the channels related to the real surround sound source of the 5.1 channels. In the embodiment, by analyzing the surround sound source of the 5.1 channels such as DVD contents and broadcast contents, the correlation value and the level difference between the channels are calculated for each genre. Concretely, as shown by a broken line 81, the correlation value and the level difference between the front-left channel and the front-center channel are used as a physical amount, and the correlation value and the level difference between the front-right channel and the front-center channel are used as a physical amount. As shown by a broken line 82a, the correlation value and the level difference between the front-left channel and the rear-left channel are used as a physical amount. As shown by a broken line 82b, the correlation value and the level difference between the front-right channel and the rear-right channel are used as a physical amount. Additionally, as shown by a broken line 83, the correlation value and the level difference between the rear-left channel and the rear-right channel are used as a physical amount.

Then, by using the above physical amounts as five-dimensional vectors, the correlation value and the level difference between the channels are calculated for each genre, based on group classification methods such as a cluster classification. For example, a popular music (hereinafter suitably referred to as “pop”), a classical music, a jazz and a fusion are used as the genre. In addition to the genre of the music content, a sport content and a movie content are used as the genre, too. Additionally, the above genre is subdivided (hereinafter, the subdivided genre is referred to as “sub-genre”). For example, the pop is subdivided into the sub-genre such as a vocal music, a nationality (Japan, the U.S. and Europe), a male artist, a female artist, a band and a group. In addition, the classical music is subdivided into the sub-genre such as an orchestra and a small-group session. The Japanese pop may be separately used as “J-pop”.

FIGS. 3A and 3B show examples of the analysis result of the real surround sound source. FIG. 3A shows an example of the correlation value and the level difference between the channels of a genre A, and FIG. 3B shows an example of the correlation value and the level difference between the channels of a genre B. Here, a description will be given of an example of the correlation value and the level difference (which are shown on the upper side) of the front-center channel with respect to the front-left channel and the front-right channel, and an example of the correlation value and the level difference (which are shown on the right side) between the front-left-right channel and the rear channel, and an example of the correlation value and the level difference (which are shown on the downside) between the rear-left channel and the rear-right channel.

Additionally, the size of the circles in FIGS. 3A and 3B represents the magnitude of level of each channel. For example, since the size of the circles of the Lch and the Rch is larger than that of the circle of the Cch, it indicates that the level of the Lch and the Rch is larger than that of the Cch. In FIG. 3A, such a situation that the level difference is a positive value indicates that the level of the Lch and the Rch is “8 (dB)” larger than that of the Cch, and the level of the front-left-right channel is “5 (dB)” larger than that of the rear channel. Therefore, it can be understood that the correlation value and the level difference between the channels differ according to the genre.

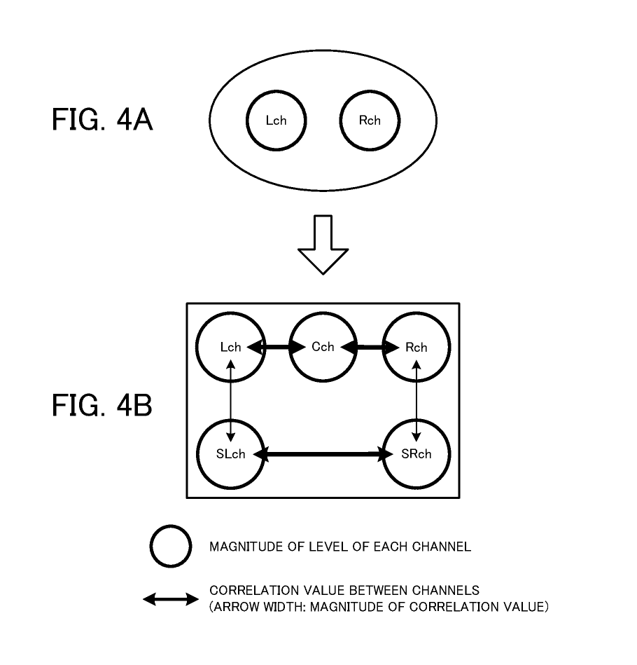

Next, FIGS. 4A and 4B are diagrams for explaining a basic concept of a method for generating the surround signals in the embodiment. FIG. 4A shows an input of the stereo sound source including the left channel and the right channel. FIG. 4B shows the 5.1 channels for which the surround signals should be generated from the stereo sound source. In FIG. 4B, the size of the circles represents the magnitude of level of each channel, and the width of the arrows represents the magnitude of the correlation value. The correlation value and the level difference are examples.

In the embodiment, based on the correlation value and the level difference between the channels which are obtained from the real surround sound source for each genre, the surround signals having the correlation value and the level difference between the channels which are appropriate for the genre are generated from the stereo sound source. Namely, the surround signals for the 5 channels are generated so that the tendency of the correlation value and the level difference of the real surround sound source for each genre is reflected.

[First Embodiment]

Next, a description will be given of a surround signal generating method in a first embodiment. In the first embodiment, based on the correlation value between the two channels in the plural channels which is preliminarily obtained by the above analysis, the amount (hereinafter referred to as “mixing amount”) for mixing two signals between the two channels is determined, and a process (hereinafter referred to as “mixing process”) of mixing the two signals is performed based on the mixing amount. Concretely, a sound signal obtained by performing an addition of the input sound signals of the two channels and a sound signal obtained by performing a subtraction of the input sound signals of the two channels are used as the above two signals. Namely, the mixing process is performed by using the sound signals having a low correlation with each other.

Specifically, in the first embodiment, a sound signal used for the front-center channel is generated by performing the mixing process based on the correlation value of the front-center channel with respect to the front-left channel and the front-right channel, and sound signals used for the rear-left channel and the rear-right channel are generated by performing the mixing process based on the correlation value between the front-left-right channel and the rear channel.

Then, in the first embodiment, the sound signals after the mixing process are controlled based on the level difference of the channels which is preliminarily obtained by the above analysis, so as to generate the surround signals for the 5 channels. In details, the surround signals for the front-left channel and the front-right channel are generated by controlling not the sound signals after the mixing process but a sound signal of the front-left channel and a sound signal of the front-right channel which are included in the input sound signals of the two channels, based on the level difference.

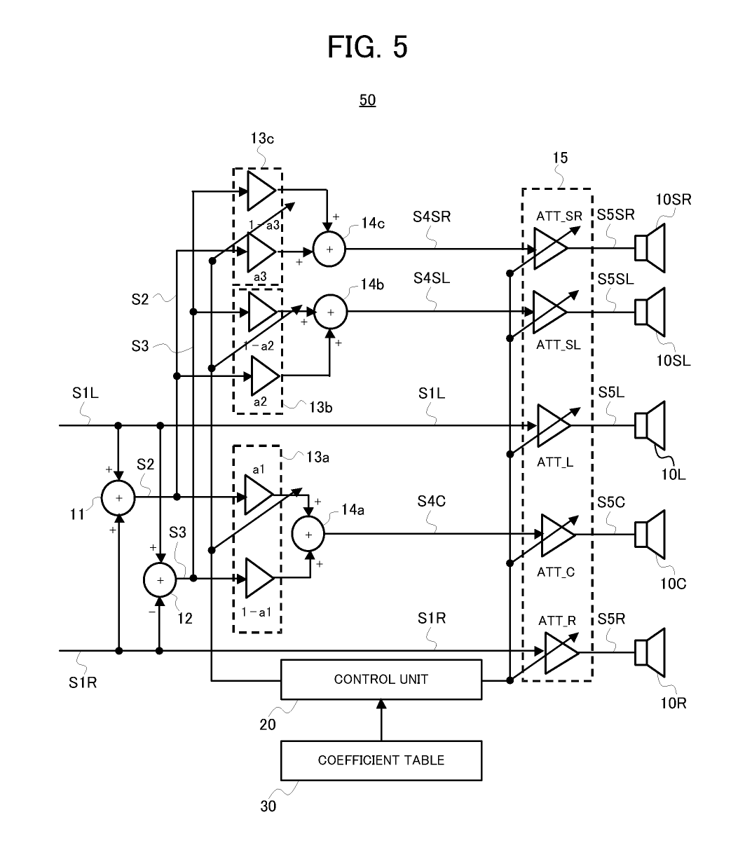

Next, a description will be given of a concrete configuration of a surround signal generating device which can realize the above surround signal generating method, with reference to FIG. 5.

FIG. 5 is a block diagram showing a surround signal generating device 50 in the first embodiment. The surround signal generating device 50 mainly includes adders 11 and 14a to 14c, a subtractor 12, correlation value control units 13a to 13c, a level difference control unit 15, a control unit 20 and a coefficient table 30. The surround signal generating device 50 generates the surround signals used for the front-left channel, the front-center channel, the front-right channel, the rear-left channel and the rear-right channel, from the input sound signals of the two channels.

The surround signal generating device 50 is provided with the sound signals for the two channels which are obtained from the stereo sound sources such as the CD (Compact Disc) and the MP3 (MPEG Audio Layer-3), as a sound signal S1L of the left channel and a sound signal S1R of the right channel. The sound signals S1L and S1R are provided to the adder 11, the subtractor 12 and the level difference control unit 15. The adder 11 provides the correlation value control units 13a to 13c with a sound signal S2 obtained by adding the sound signal S1L of the left channel to the sound signal S1R of the right channel. The subtractor 12 provides the correlation value control units 13a to 13c with a sound signal S3 obtained by subtracting the sound signal S1R of the right channel from the sound signal S1L of the left channel. Namely, the adder 11 and subtractor 12 generate the sound signals S2 and S3 having a low correlation with each other.

The control unit 20 obtains a coefficient in accordance with the genre of the content from the coefficient table 30, and controls the correlation value control units 13a to 13c and the level difference control unit 15 based on the obtained coefficients. The coefficient in accordance with the correlation value and the level difference between the channels which are preliminarily obtained by the above analysis is stored in the coefficient table 30, for each genre. Concretely, mixing coefficients al, a2 and a3 for controlling the correlation value and gain amounts ATT_L, ATT₁₃ R, ATT_C, ATT_SL and ATT_SR for controlling the level difference are stored in the coefficient table 30, for each genre.

The mixing coefficient al is set based on the correlation value of the front-center channel with respect to the front-left channel and the front-right channel. The mixing coefficients a2 and a3 are set based on the correlation value between the front-left-right channel and the rear channel. Based on a relationship (map) between the mixing coefficient and the correlation value which are obtained by preliminarily performing an experiment, for example, the mixing coefficients a1 to a3 are determined in accordance with the correlation value between the channels. Additionally, the mixing coefficients a1 to a3 correspond to the above mixing amount, and the mixing coefficients a1 to a3 are equal to or smaller than “1”.

The gain amounts ATT_L, ATT_C, ATT_R, ATT_SL and ATT_SR are set in accordance with the level difference of the front-left channel, the front-center channel, the front-right channel, the rear-left channel and the rear-right channel, respectively.

In the coefficient table 30, the mixing coefficients and the gain amounts are stored in association with the genre such as the pop, the classical music, the jazz, the fusion, the sport content and the movie content. Additionally, in the coefficient table 30, the mixing coefficients and the gain amounts are stored in association with the sub-genre for which the above genre is subdivided. For example, as for the pop, the mixing coefficients and the gain amounts are stored in association with the sub-genre such as the vocal music, the nationality, the male artist, the female artist, the band and the group.

For example, the control unit 20 obtains the mixing coefficients and the gain amounts in accordance with the genre, from the coefficient table 30, by obtaining the genre input by a user, or by obtaining the genre from tag information of the MP3. In this case, the control unit 20 can obtain the mixing coefficients and the gain amounts in accordance with the sub-genre, by obtaining information of the sub-genre for which the above genre is subdivided, from the user.

The correlation value control unit 13a performs a control in accordance with the mixing coefficient al from the control unit 20. Concretely, the correlation value control unit 13a provides the adder 14a with a sound signal obtained by multiplying the sound signal S2 by “a1” and a sound signal obtained by multiplying the sound signal S3 by “1-a1”. The adder 14a generates a sound signal S4C by adding the two signals provided by the correlation value control unit 13a, and provides the level difference control unit 15 with the sound signal S4C. The correlation value control unit 13b performs a control in accordance with the mixing coefficient a2 from the control unit 20. Concretely, the correlation value control unit 13b provides the adder 14b with a sound signal obtained by multiplying the sound signal S2 by “a2” and a sound signal obtained by multiplying the sound signal S3 by “1-a2”. The adder 14b generates a sound signal S4SL by adding the two signals provided by the correlation value control unit 13b, and provides the level difference control unit 15 with the sound signal S4SL. The correlation value control unit 13c performs a control in accordance with the mixing coefficient a3 from the control unit 20. Concretely, the correlation value control unit 13c provides the adder 14c with a sound signal obtained by multiplying the sound signal S2 by “a3” and a sound signal obtained by multiplying the sound signal S3 by “1-a3”. The adder 14c generates a sound signal S4SR by adding the two signals provided by the correlation value control unit 13c, and provides the level difference control unit 15 with the sound signal S4SR. Thus, the correlation value control units 13a to 13c and the adders 14a to 14c function as the mixing processing unit.

The level difference control unit 15 is provided with the above sound signals S1L, S4C, S1R, S4SL and S4SR. The level difference control unit 15 multiplies the sound signals S1L, S4C, S1R, S4SL and S4SR by the gain amounts ATT_L, ATT_C, ATT_R, ATT_SL and ATT_SR, respectively, so as to generate sound signals S5L, S5C, S5R, S5SL and S5SR. Then, the level difference control unit 15 provides the front-left speaker 10L, the front-center speaker 10C, the front-right speaker 10R, the rear-left speaker 10SR and the rear-right speaker 10SR with the sound signals S5L, S5C, S5R, S5SL and S5SR, respectively.

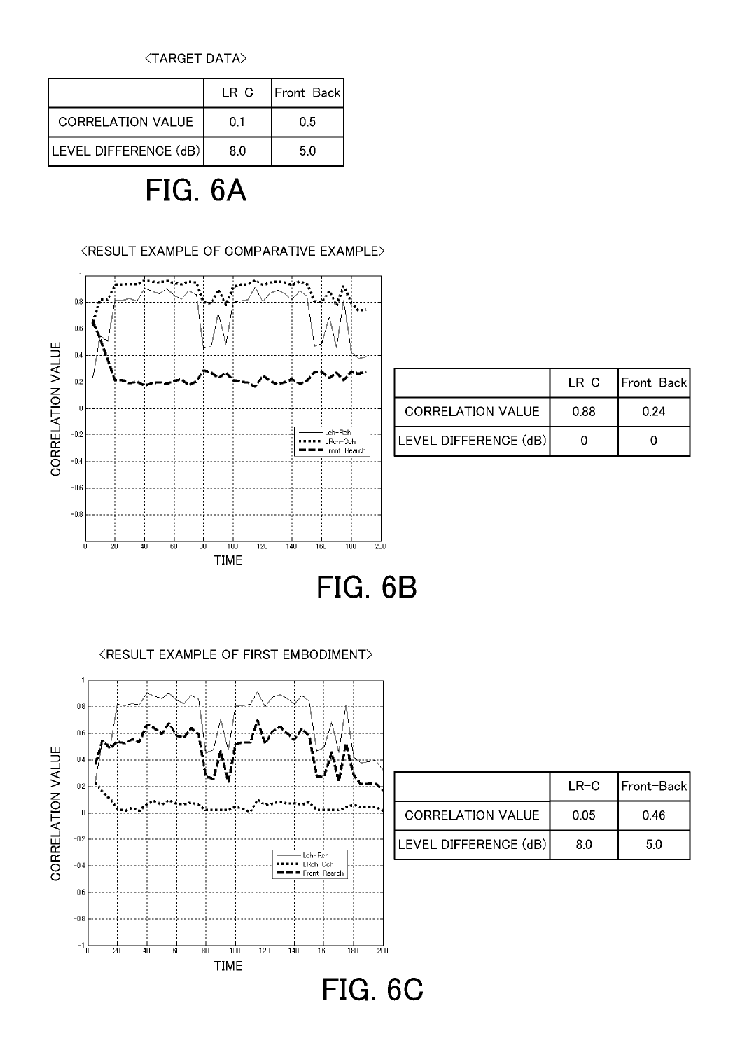

Next, a description will be given of an effect of the surround signal generating method in the first embodiment, with reference to FIGS. 6A to 6C. FIG. 6A shows data of the surround signals which is used as a target. Namely, the data (target data) of the surround signals which should be realized is shown. As shown in FIG. 6A, the correlation value of the front-center channel with respect to the front-left channel and the front-right channel is “0.1”, and the level difference is “8.0 (dB)”. Additionally, the correlation value between the front-left-right channel and the rear channel is “0.5”, and the level difference is “5.0 (dB)”.

FIG. 6B shows an example of an analysis result of the surround signals generated by a method of a comparative example. As for the method of the comparative example, without consideration of the correlation value and the level difference between the channels, a component having a high correlation with the left channel and the right channel is assigned to the front-center channel and a component having a low correlation with the left channel and the right channel is assigned to the rear-left channel and the rear-right channel, in order to generate the surround signals (The same will apply hereinafter). As shown in FIG. 6B, by the method of the comparative example, “0.88” is obtained as the correlation value of the front-center channel with respect to the front-left channel and the front-right channel, and “0 (dB)” is obtained as the level difference. Additionally, “0.24” is obtained as the correlation value between the front-left-right channel and the rear channel, and “0 (dB)” is obtained as the level difference. Therefore, by the method of the comparative example, it can be understood that the surround signals as shown in FIG. 6A are not appropriately realized.

FIG. 6C shows an example of an analysis result of the surround signals generated by the method of the first embodiment. As shown in FIG. 6c, by the method of the first embodiment, “0.05” is obtained as the correlation value of the front-center channel with respect to the front-left channel and the front-right channel, and “8.0 (dB)” is obtained as the level difference. Additionally, “0.46” is obtained as the correlation value between the front-left-right channel and the rear channel, and “5.0 (dB)” is obtained as the level difference . Therefore, by the method of the first embodiment, it can be understood that the surround signals as shown in FIG. 6A are appropriately realized.

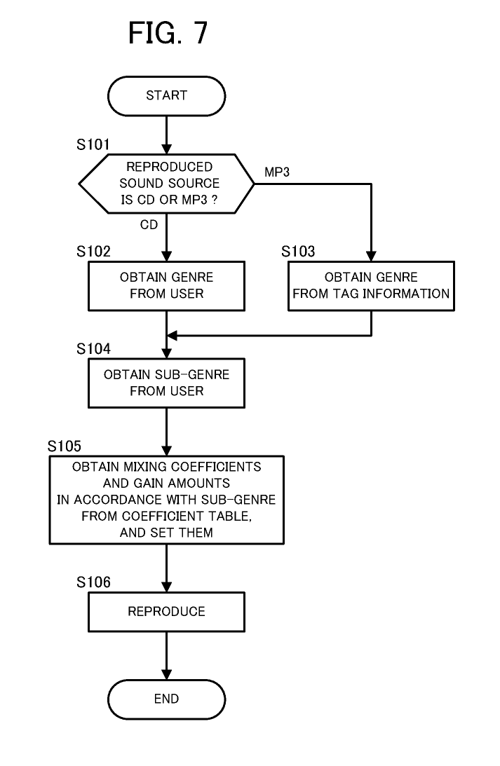

Next, a description will be given of a concrete process performed by the surround signal generating device 50 in the first embodiment, with reference to FIG. 7. FIG. 7 is a flow chart showing the process performed by the control unit 20 in the surround signal generating device 50. For example, the process is performed when the genre of the reproduced content changes and/or the reproduced sound source changes.

First, in step S101, the control unit 20 determines whether the reproduced sound source is the CD or the MP3. When the reproduced sound source is the CD, the process goes to step S102. In step S102, the control unit 20 requires the user to input the genre, and obtains the genre input by the user. For example, the user inputs the genre of the content stored in the reproduced CD, by a key input. Then, the process goes to step S104.

In contrast, when the reproduced sound source is the MP3, the process goes to step S103. In step S103, the control unit 20 refers to the tag information of the MP3, and obtains the genre of the reproduced content. Then, the process goes to step S104.

In step S104, the control unit 20 requires the user to input the sub-genre, and obtains the sub-genre input by the user. For example, the control unit 20 displays the sub-genre related to the genre obtained in step S102 or S103, so as to make the user select the sub-genre. As an example, when the genre is “J-pop”, the user selects one of the male artist, the female artist, the band and the group, as the sub-genre. Then, the process goes to step S105.

In step S105, by referring to the coefficient table 30, the control unit 20 obtains the mixing coefficients and the gain amounts in accordance with the sub-genre obtained in step S104, and sets the obtained mixing coefficients and the gain amounts. Concretely, the control unit 20 sets the obtained mixing coefficients and the obtained gain amounts, to the correlation value control units 13a to 13c and the level difference control unit 15. Then, the process goes to step S106, and the content is reproduced. After that, the process ends.

By the above first embodiment, it becomes possible to appropriately generate the surround signals having the correlation value and the level difference between the channels which are appropriate for the genre of the content.

While the above embodiment shows such an example that the control unit 20 obtains the genre input by the user and such an example that the control unit 20 obtains the genre from the tag information of the MP3, it is not limited to these examples. As another example, the control unit 20 can obtain the genre from a server. As still another example, instead of obtaining the genre as described above, the genre can be identified by analyzing the input sound signals.

[Second Embodiment]

Next, a description will be given of a surround signal generating method in a second embodiment. The second embodiment is different from the first embodiment in that an uncorrelated signal which is uncorrelated with each channel is generated from the input sound signals of the two channels so as to perform the mixing process by using the uncorrelated signal. Concretely, in the second embodiment, the mixing process is performed by using the uncorrelated signal so as to generate sound signals used for the rear-left channel and the rear-right channel. Therefore, it becomes possible to appropriately control the correlation value between the rear-left channel and the rear-right channel.

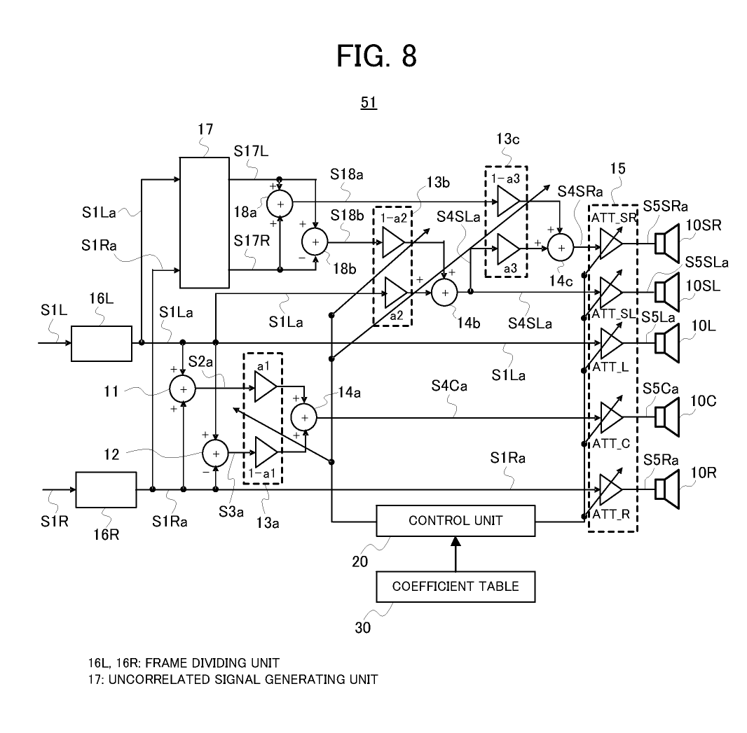

FIG. 8 is a block diagram showing a surround signal generating device 51 in the second embodiment. The surround signal generating device 51 mainly includes adders 11, 14a to 14c and 18a, subtractors 12 and 18b, correlation value control units 13a to 13c, a level difference control unit 15, flame dividing units 16L and 16R, an uncorrelated signal generating unit 17, a control unit 20 and a coefficient table 30. The components to which the same reference numerals as those of the surround signal generating device 50 (see FIG. 5) are given basically have same functions as those of the surround signal generating device 50, and explanations thereof are omitted.

As for the surround signal generating device 51, the sound signal S1L of the left channel and the sound signal S1R of the right channel are provided to the flame dividing units 16L and 16R, respectively. The flame dividing units 16L and 16R divide the sound signals S1L and S1R by a predetermined time unit. Then, the flame dividing units 16L and 16R provide the adder 11, the subtractor 12, the level difference control unit 15 and the uncorrelated signal generating unit 17 with the divided sound signals S1La and S1Ra. The flame dividing units 16L provides the correlation value control unit 13b with the sound signal S1La, too.

The adder 11 provides the correlation value control unit 13a with a sound signal S2a obtained by adding the sound signal S1La to the sound signal S1Ra, and the subtractor 12 provides the correlation value control unit 13a with a sound signal S3a by subtracting the sound signal S1Ra from the sound signal S1La. The correlation value control unit 13a provides the adder 14a with a sound signal obtained by multiplying the sound signal Sts by “a1” and a sound signal obtained by multiplying the sound signal S3a by “1-al”. The adder 14a generates a sound signal S4Ca by adding the two signals provided by the correlation value control unit 13a, and provides the level difference control unit 15 with the sound signal S4Ca.

The control unit 20 obtains the mixing coefficients a1, a2 and a3 and the gain amounts ATT_L, ATT_R, ATT_C, ATT_SL and ATT_SR in accordance with the genre of the content, from the coefficient table 30, and controls the correlation value control units 13a to 13c and the level difference control unit 15 based on the mixing coefficients and the gain amounts. The mixing coefficients a1, a2 and a3 and the gain amounts ATT_L, ATT_R, ATT_C, ATT_SL and ATT_SR are preliminarily stored in the coefficient table 30, for each genre (including the sub-genre).

The uncorrelated signal generating unit 17 generates uncorrelated signals S17L and S17R which are uncorrelated with each channel, based on the sound signals S1La and S1Ra, and provides the adder 18a and the subtractor 18b with the uncorrelated signals S17L and S17R. The adder 18a provides the correlation value control unit 13c with a signal S18a obtained by adding the uncorrelated signal S17L to the uncorrelated signal S17R, and the subtractor 18b provides the correlation value control unit 13b with a signal S18b obtained by subtracting the uncorrelated signal S17R from the uncorrelated signal S17L.

The correlation value control unit 13b performs a control in accordance with the mixing coefficient a2 from the control unit 20. Concretely, the correlation value control unit 13b provides the adder 14b with a sound signal obtained by multiplying the sound signal S1La by “a2” and a signal obtained by multiplying the signal S18b by “1-a2”. The adder 14b generates a sound signal S4SLa by adding the two signals provided by the correlation value control unit 13b, and provides the correlation value control unit 13c and the level difference control unit 15 with the sound signal S4SLa.

The correlation value control unit 13c performs a control in accordance with the mixing coefficient a3 from the control unit 20. Concretely, the correlation value control unit 13c provides the adder 14c with a sound signal obtained by multiplying the sound signal S4SLa by “a3” and a signal obtained by multiplying the signal S18a by “1-a3”. The adder 14c generates a sound signal S4SRa by adding the two signals provided by the correlation value control unit 13c, and provides the level difference control unit 15 with the sound signal S4SRa.

The level difference control unit 15 is provided with the above sound signals S1La, S4Ca, S1Ra, S4SLa and S4SRa. The level difference control unit 15 multiplies the sound signals S1La, S4Ca, S1Ra, S4SLa and S4SRa by the gain amounts ATT_L, ATT_C, ATT_R, ATT_SL and ATT_SR, respectively, so as to generate sound signals S5La, S5Ca, S5Ra, S5SLa and S5SRa. Then, the level difference control unit 15 provides the front-left speaker 10L, the front-center speaker 10C, the front-right speaker 10R, the rear-left speaker 10SR and the rear-right speaker 10SR with the sound signals S5La, S5Ca, S5Ra, S5SLa and S5SRa, respectively.

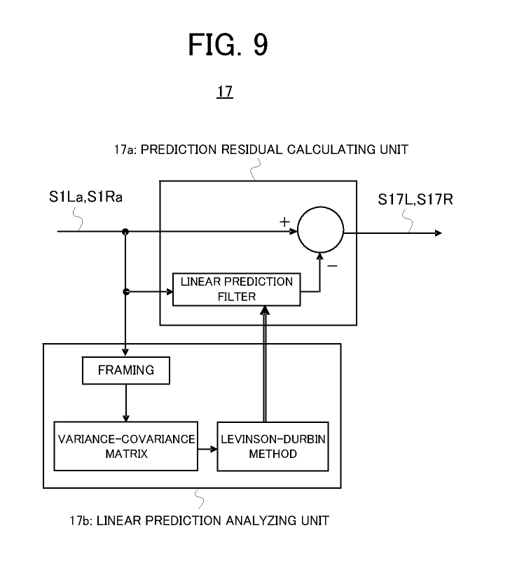

Next, a description will be given of a concrete example of the uncorrelated signal generating unit 17, with reference to FIG. 9. FIG. 9 is a schematic diagram showing process blocks of the uncorrelated signal generating unit 17. The uncorrelated signal generating unit 17 mainly includes a prediction residual calculating unit 17a and a linear prediction analyzing unit 17b. Basically, the uncorrelated signal generating unit 17 generates the uncorrelated signals based on a linear prediction residual.

The prediction residual calculating unit 17a and the linear prediction analyzing unit 17b are provided with the sound signals S1La and S1Ra for one frame, which are processed by the flame dividing units 16L and 16R. The linear prediction analyzing unit 17b performs a framing of the sound signals S1La and S1Ra so as to generate a variance-covariance matrix, and performs a linear prediction based on a Levinson-Durbin method. In this case, the linear prediction analyzing unit 17b calculates a linear prediction filter coefficient. The prediction residual calculating unit 17a performs a filter process of the sound signals S1La and S1Ra by using the linear prediction filter coefficient. Then, the prediction residual calculating unit 17a outputs a value (linear prediction residual) obtained by subtracting the signal after the filter process from the sound signals S1La and S1Ra, as the uncorrelated signals S17L and S17R.

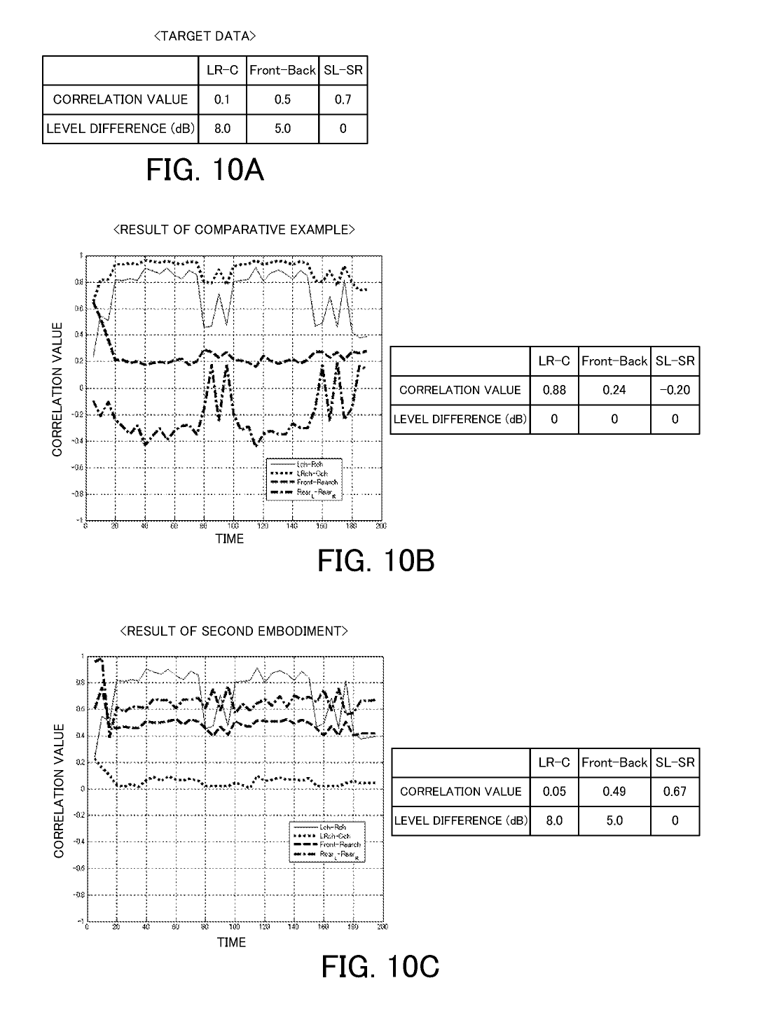

Next, a description will be given of an effect of the surround signal generating method in the second embodiment, with reference to FIGS. 10A to 10C. FIG. 10A shows data of the surround signals which is used as a target. Namely, the data (target data) of the surround signals which should be realized is shown. As shown in FIG. 10A, the correlation value of the front-center channel with respect to the front-left channel and the front-right channel is “0.1”, and the level difference is “8.0 (dB)”. The correlation value between the front-left-right channel and the rear channel is “0.5”, and the level difference is “5.0 (dB)”. Additionally, the correlation value between the rear-left channel and the rear-right channel is “0.7”.

FIG. 10B shows an example of an analysis result of the surround signals generated by the method of the comparative example. As shown in FIG. 10B, by the method of the comparative example, “0.88” is obtained as the correlation value of the front-center channel with respect to the front-left channel and the front-right channel, and “0 (dB)” is obtained as the level difference. Additionally, “0.24” is obtained as the correlation value between the front-left-right channel and the rear channel, and “0 (dB)” is obtained as the level difference. Additionally, “−0.20” is obtained as the correlation value between the rear-left channel and the rear-right channel. Therefore, by the method of the comparative example, it can be understood that the surround signals as shown in FIG. 10A are not appropriately realized.

FIG. 10C shows an example of an analysis result of the surround signals generated by the method of the second embodiment. As shown in FIG. 10c, by the method of the second embodiment, “0.05” is obtained as the correlation value of the front-center channel with respect to the front-left channel and the front-right channel, and “8.0 (dB)” is obtained as the level difference. Additionally, “0.49” is obtained as the correlation value between the front-left-right channel and the rear channel, and “5.0 (dB)” is obtained as the level difference. Additionally, “0.67” is obtained as the correlation value between the rear-left channel and the rear-right channel. Therefore, by the method of the second embodiment, it can be understood that the surround signals as shown in FIG. 10A are appropriately realized. Specifically, it can be understood that the correlation value between the rear-left channel and the rear-right channel is appropriately realized.

According to the above second embodiment, since the mixing process is performed based on the uncorrelated signals, it becomes possible to generate the surround signals for which the correlation value between the rear-left channel and the rear-right channel is appropriately controlled.

[Modification]

The above embodiments show such an example that the surround signals are generated based on the correlation value of the front-center channel with respect to the front-left channel and the front-right channel, the correlation value between the front-left-right channel and the rear channel, and the correlation value between the rear-left channel and the rear-right channel. However, the surround signals may be generated based on the correlation value between channels other than the above-mentioned channels.

While the above embodiments show such an example that the present invention is applied to the 5.1-channel system (namely, such an example that the surround signals for 5 channels are generated from the sound signals of the two channels), it is not limited to this. Other than the 5.1-channel system, the present invention can be applied to a configuration which generates surround signals for more than 2 channels from the sound signals of the two channels.

While the above embodiments show such an example that the surround signals are generated based on both the correlation value and the level difference, the surround signals may be generated based on either the correlation value or the level difference. Namely, the surround signals may be generated by only controlling the correlation value without controlling the level difference, or the surround signals may be generated by only controlling the level difference without controlling the correlation value.

In the above embodiments, it is assumed that the calculation for generating the surround signals is basically performed by a circuit. However, the calculation may be performed by a software process. For example, the functions of the surround signal generating devices 50 and 51 are realized by a program executed by a CPU (computer). As an example, the program may be preliminarily stored in a hard disk or a ROM. As another example, the program may be provided via a computer-readable recording medium such as a CD-ROM, and the program for which a CD-ROM drive reads the recording medium may be stored in the hard disc.

### INDUSTRIAL APPLICABILITY

This invention can be used for various kinds of audio devices.

### DESCRIPTION OF REFERENCE NUMBERS

10 Speaker

11, 14a to 14c Adder

12 Subtractor

13a to 13c Correlation Value Control Unit

15 Level Difference Control Unit

17 Uncorrelated Signal Generating Unit

20 Control Unit

30 Coefficient Table

50, 51 Surround Signal Generating Device

1. A surround signal generating device which generates surround signals of plural channels from input sound signals of two channels, comprising:
a setting unit which sets a correlation value between channels in the plural channels and/or a level difference of the plural channels, in accordance with a genre of a content corresponding to the sound signals; and
a surround signal generating unit which generates the surround signals of the plural channels based on the correlation value and/or the level difference which are set by the setting unit,
wherein, based on the correlation value between the channels in the plural channels and/or the level difference of the plural channels which are obtained from a real surround sound source for each genre, the setting unit sets the correlation value and/or the level difference.

2. (canceled)

3. The surround signal generating device according to claim 1,
wherein the surround signal generating unit includes a mixing processing unit which determines an amount for mixing two signals between two channels in the plural channels based on the correlation value between the two channels which is set by the setting unit, and performs a process of mixing the two signals based on the amount.

4. The surround signal generating device according to claim 3,
wherein the mixing processing unit uses, as the two signals, a sound signal obtained by performing an addition of the input sound signals of the two channels and a sound signal obtained by performing a subtraction of the input sound signals of the two channels, and performs the process of mixing the two signals.

5. The surround signal generating device according to claim 3,
wherein the two channels comprise a left channel and a right channel,
wherein the plural channels are 5 channels comprising a front-left channel, a front-center channel, a front-right channel, a rear-left channel and a rear-right channel,
wherein the mixing processing unit performs the process based on the correlation value of the front-center channel with respect to the front-left channel and the front-right channel, so as to generate a sound signal used for the front-center channel, and
wherein the mixing processing unit performs the process based on the correlation value of a rear channel comprising the rear-left channel and the rear-right channel with respect to the front-left channel and the front-right channel included in a front channel comprising the front-left channel, the front-center channel and the front-right channel, so as to generate sound signals used for the rear-left channel and the rear-right channel.

6. The surround signal generating device according to claim 3,
wherein the surround signal generating unit further includes an uncorrelated signal generating unit which generates an uncorrelated signal which is uncorrelated with each channel in the plural channels, based on the input sound signals of the two channels, and
wherein the mixing processing unit performs the process by using the uncorrelated signal.

7. The surround signal generating device according to claim 6,
wherein the uncorrelated signal generating unit generates the uncorrelated signal based on a linear prediction residual.

8. The surround signal generating device according to claim 6,
wherein the two channels comprise a left channel and a right channel,
wherein the plural channels are 5 channels comprising a front-left channel, a front-center channel, a front-right channel, a rear-left channel and a rear-right channel, and
wherein the mixing processing unit performs the process by using the uncorrelated signal so as to generate sound signals used for the rear-left channel and the rear-right channel.

9. The surround signal generating device according to claim 3,
wherein the surround signal generating unit controls the sound signals after the process by the mixing processing unit, based on the level difference of the plural channels which is set by the setting unit, so as to generate the surround signals of the plural channels.

10. The surround signal generating device according to claim 1,
wherein the setting unit obtains the genre from an external input.

11. The surround signal generating device according to claim 1,
wherein the setting unit obtains the genre from tag information attached to the input sound signals of the two channels.

12. The surround signal generating device according to claim 1, further comprising a unit which identifies the genre by analyzing the input sound signals of the two channels,
wherein the setting unit uses the identified genre.

13. A surround signal generating method which generates surround signals of plural channels from input sound signals of two channels, comprising:
a setting process which sets a correlation value between channels in the plural channels and/or a level difference of the plural channels, in accordance with a genre of a content corresponding to the sound signals; and
a surround signal generating process which generates the surround signals of the plural channels based on the correlation value and/or the level difference which are set by the setting process,
wherein, based on the correlation value between the channels in the plural channels and/or the level difference of the plural channels which are obtained from a real surround sound source for each genre, the setting process sets the correlation value and/or the level difference.

14. A computer program product in a non-transitory computer-readable medium executed by a surround signal generating device comprising a computer, which generates surround signals of plural channels from input sound signals of two channels, making the computer function as:
a setting unit which sets a correlation value between channels in the plural channels and/or a level difference of the plural channels, in accordance with a genre of a content corresponding to the sound signals; and
a surround signal generating unit which generates the surround signals of the plural channels based on the correlation value and/or the level difference which are set by the setting unit,
wherein, based on the correlation value between the channels in the plural channels and/or the level difference of the plural channels which are obtained from a real surround sound source for each genre, the setting unit sets the correlation value and/or the level difference.
